(19) United States
(12) Patent Application Publication
(10) Pub. No.: US 2012/0275195 A1
(43) Pub. Date: Nov. 1, 2012

(54) Low Noise, Highly Isolated Power Supply

(76) Inventors: Lorenzo Cividino, Franklin, MA (US); Thomas Ingman, Somis, CA (US); Tuan Le, Winnetka, CA (US)

(21) Appl. No.: 13/455,043

(22) Filed: Apr. 24, 2012

Related U.S. Application Data
(60) Provisional application No. 61/480,285, filed on Apr. 28, 2011.

(51) Int. Cl. H02M 3/22

(52) U.S. Cl. 363/15

(57) ABSTRACT

A power supply may include a power transformer having a primary winding and a secondary winding, one end of the secondary winding connected to ground, and a shielded isolation transformer having a third winding, a fourth winding, and a shield, wherein the third winding is connected to the secondary winding and the shield is connected to ground. Primary side circuits may receive input power and generate a primary AC signal to drive the primary winding. Secondary side circuits may convert a secondary AC signal output from the fourth winding into a DC output.

### RELATED APPLICATION INFORMATION

This patent claims priority from Provisional Patent Application No. 61/480,285, filed Apr. 28, 2011, entitled Noise Reduction in Highly Isolated Power Supplies, which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to power supplied for medical devices.

2. Description of the Related Art

FIG. 1 is a block diagram of a representative conventional DC power supply 100. The power supply 100 receives a power input 105, which may be a single-phase or three-phase AC line voltage or a DC voltage, and provides an isolated DC output 195. The power input may typically be a single phase AC line have a frequency of 50 Hz or 60 Hz and a voltage from 100 to 240 volts RMS. The DC output 195 may be a voltage or current, regulated or unregulated. All of the elements of the power supply 100 are known to a person of skill in the art of switching mode power supplies.

The power supply 100 may include a rectifier 110, such as a half wave rectifier or a full wave bridge rectifier, and a filter 120 to convert AC line input power 105 to an internal DC voltage 125. In cases where the power supply 100 receives DC input power, the rectifier 110 and/or the filter 120 may not be present.

An inverter 130 may convert the internal DC voltage 125 into a high frequency AC primary voltage 135. In this context, the term “high frequency” means substantially higher frequency than the AC line input. The frequency of the AC primary voltage 135 may be, for example, from 20 kHz to 200 kHz. The inverter may include one or more switching transistors. A number of inverter configurations are well-known in the art including flyback inverters, half-bridge inverters, full-bridge inverters, and other configurations.

The high frequency AC primary voltage 135 output from the inverter 130 may drive a primary winding of a power transformer 140. A secondary winding of the power transformer 140 may output an AC secondary voltage 145 having the same frequency as the AC primary voltage applied to the primary of the power transformer 140. The relative amplitude of the AC secondary voltage 145 to the AC primary voltage 135 may be determined by the power transformer design. The power transformer 140 may commonly be a step-down transformer wherein the AC secondary voltage 145 may have a smaller amplitude that the AC primary voltage 135.

A second rectifier 150 and a second filter 160 convert the AC secondary voltage 145 into the DC output 195. The second rectifier 150 may be a half wave rectifier, a full wave rectifier, a bridge rectifier, or some other configuration. The second rectifier 150 may use diode rectifiers and/or synchronous rectifiers. The second filter 160 may be configured to remove noise and ripple and to store energy for delivery to a load (not shown) connected to the DC output 195.

When a regulated DC output 195 is required, a feedback circuit 170 may sense a voltage and/or a current of the DC output 195 and provide a feedback signal 175 to a control circuit 180. The control circuit 180 may control the operation of the inverter 130 to achieve regulation of the DC output 195. Commonly, the inverter 130 may generate a pulse-width modulated AC signal, where the pulse width is controlled by the control circuit 180 in response to the feedback 175.

The power transformer 140 may provide DC isolation between primary side circuits and secondary side circuits. “Primary side circuits” are circuits (including the rectifier 110, the filter 120, the inverter 130, and the control circuit 180 if present) coupled to the primary winding of the power transformer 140). “Secondary side circuits” are circuits (including the second rectifier 150 and the second filter 160, and the feedback circuit 170 if present) coupled to the secondary winding of the power transformer 140. To preserve the DC isolation between the primary side circuits and the secondary side circuits, the feedback signal 175 may be optically coupled or galvanically isolated from the feedback circuit 170 to the control circuit 180.

The power input 105 may include common mode noise, which is noise that appears in both power input lines. Such noise can be considered to be generated by a noise voltage source Vn or the power line source between one of the power input lines and ground. Although the power transformer 140 provides DC isolation between the primary side circuits and the secondary side circuits of the power supply 100, a parasitic capacitance Cs between the primary winding and the secondary winding of the transformer 140 may couple at least a portion of the common mode noise Vn from the primary side circuits to the secondary side circuits. Common mode noise at the DC output 195 may be attenuated or eliminated by grounding one side of the DC output 195 or by shunting the common mode noise to ground through at least one capacitor C1.

The operation of the human heart can be disrupted by electric shock current of as little as 10's of microamps. Thus medical devices which can come in contact with patient tissue must maintain extreme isolation between the device and ground to prevent electrical shock hazards. Such medical devices include cardiac monitoring or therapy devices such as EKG monitors, ECG monitors, EEG monitors, pacemaker programming apparatus, and other devices used in patient monitoring and therapy. A medical device that is powered from a hazardous source such as the 50 or 60 Hz AC primary power must meet stringent specifications for design and construction, and must have a very high impedance (i.e. very high resistance and very low capacitance) between any components connected to the patient and ground. These requirements apply to both the medical device and to the power supply powering the medical device. Thus conventional approaches to common mode noise control, such as grounding one side of the output or shunting common mode noise to ground through a capacitor, cannot be employed in power supplies for some medical devices. Without such noise control measures, common mode noise may interfere with the signals used in or by the medical device.

### DESCRIPTION OF THE DRAWINGS

FIG. 1 is a block diagram of a conventional power supply.

FIG. 2 is a block diagram of a low noise, highly isolated power supply.

FIG. 3 is a block diagram of another low noise, highly isolated power supply.

Throughout this description, elements appearing in figures are assigned three-digit reference designators where the most significant digit is the figure number where the element is introduced. An element that is not described in conjunction with a figure may be presumed to have the same characteristics and function as a previously-described element having the same reference designator.

### DETAILED DESCRIPTION

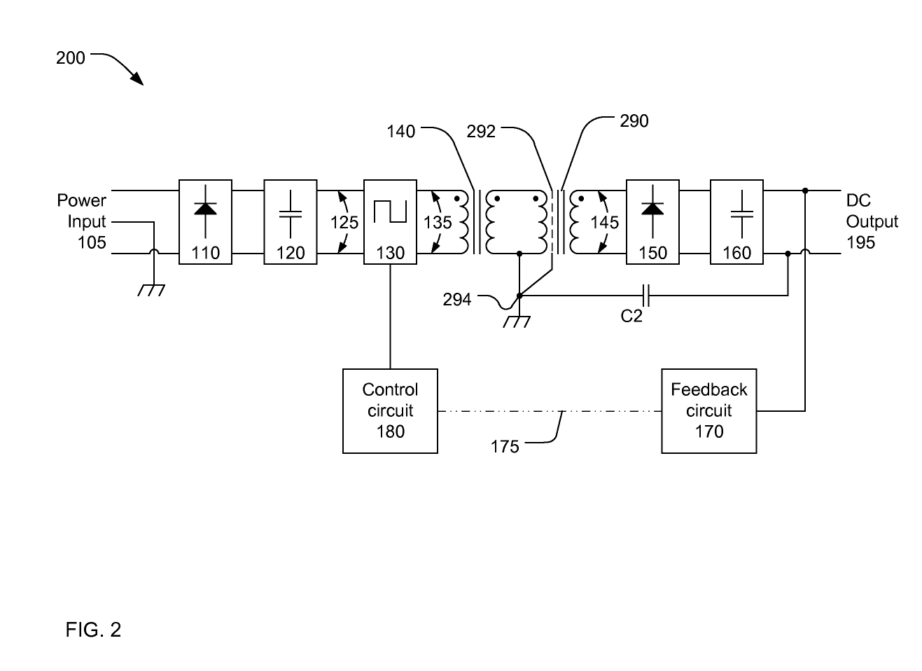

FIG. 2 is a block diagram of an exemplary low noise, highly isolated power supply 200. The power supply 200 may receive an AC line input voltage 105 and provide an isolated DC output 195. The DC output 195 may be a voltage or current, regulated or unregulated.

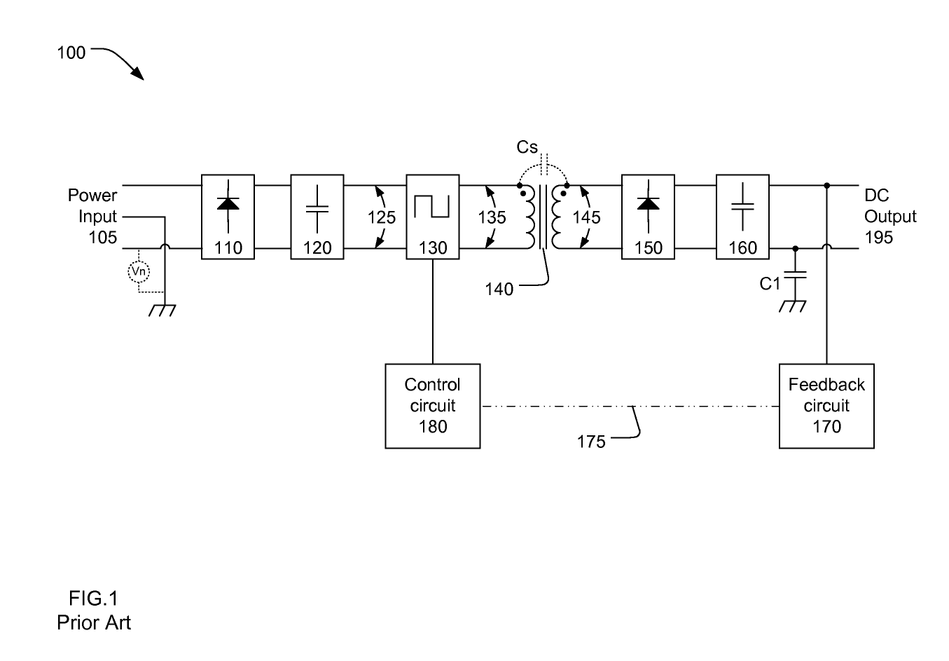

Many elements of the power supply 200 may have the same configuration and function as similarly numbered elements of the power supply 100 of FIG. 1. Common elements of the power supply 200 and the power supply 100 include the primary side rectifier 110 and filter 120, the inverter 130, the power transformer 140, the secondary side rectifier 150 and filter 160, the feedback circuit 170 and the control circuit 180. Descriptions of these common elements will not be repeated.

The power supply 200 includes a shielded isolation transformer 290 not found in the conventional power supply 100. The shielded isolation transformer 290 may include a primary winding connected to the secondary winding of power transformer 140. A secondary winding of the shield isolation transformer 290 may provide the secondary AC voltage 145 to the secondary side rectifier 150. The shielded isolation transformer 290 may be configured for operation at the frequency (for example, from 20 kHz to 200 kHz) of the AC primary voltage 135 output from the inverter 130. The primary and secondary windings of the shielded isolation transformer 290 may be separated by an internal electrostatic shield 292 (schematically represented as a dashed line). The electrostatic shield 292 may be configured to substantially reduce or eliminate parasitic capacitance between the primary and secondary windings of the shielded isolation transformer 290.

The presence of the shielded isolation transformer 290 may substantially reduce common mode noise at the DC output 195. First, the isolation provided by the shielded isolation transformer 290 allows one end of the secondary winding of power transformer 140 to be connected to ground, while isolation between the DC output 195 and ground is still provided. Grounding one end of the secondary winding of power transformer 140 may substantially reduce common mode noise coupled from the AC line input 105 via the parasitic capacitance (Cs in FIG. 1) of the power transformer 140. Further, the electrostatic shield 292 within the shielded isolation transformer 290 may substantially prevent any residual common mode noise from being coupled to the secondary of the shielded isolation transformer 290. To maintain high frequency isolation between the primary side circuits and the secondary side circuits, the feedback 175 may be provided via a low capacitance optical isolator. In addition, to further minimize common mode noise at the DC output 195, a very small established reliability capacitor C2 may be connected from the either the positive or negative side of the DC output 195 to ground. The capacitor C2 may have a capacitance value from 0 to 100 pF, and may be about 50 pF. The secondary of power transformer 140, the electrostatic shield 292, and capacitor C2 may be connected to ground at a common point 294.

An “established reliability” capacitor is manufactured using rigorously controlled processes and extensive testing to ensure very long component life. Established reliability components are well-known and commonly used in applications like medical equipment and equipment for use in space.

Shielded isolation transformers are known in the art as a method for reducing common mode noise in AC power circuits. Some of the benefits of the shielded isolation transformer 290 might be obtained by placing a conventional shielded isolation transformer between the AC line and the AC line input 105 of the power supply. However, a shielded isolation transformer for use at the 50 Hz or 60 Hz frequency of the AC line would be substantially larger and heavier than the shielded isolation transformer 290, which is configured for operation at the high frequency (e.g. 20 kHz to 200 kHz) output by the inverter 130.

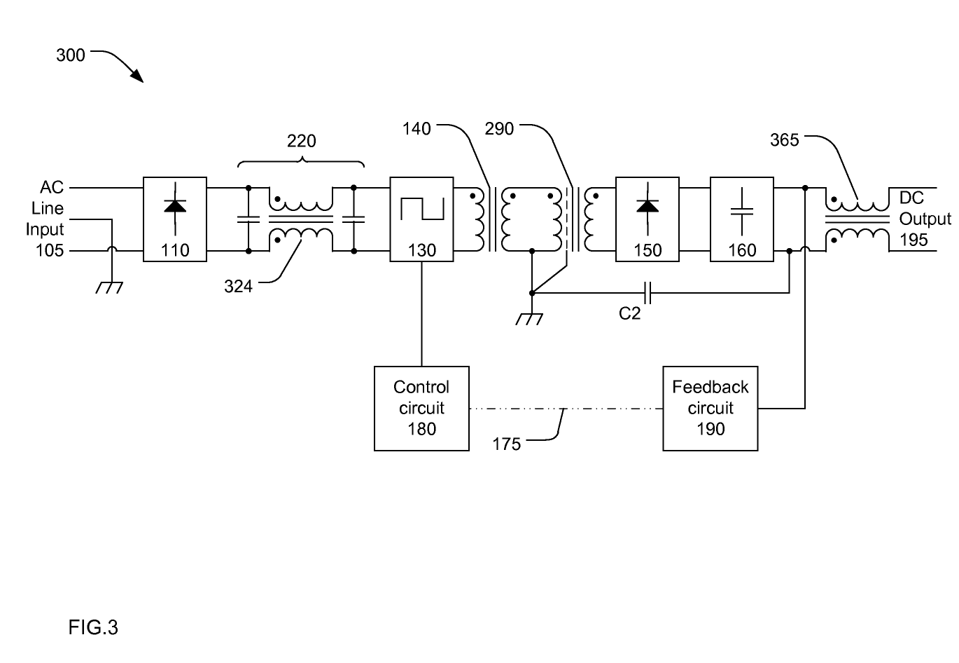

FIG. 3 is a block diagram of another exemplary low noise, highly isolated power supply 200. Many elements of the power supply 300 may have the same configuration and function as similarly numbered elements of the power supply 200 of FIG. 2. Descriptions of these common elements will not be repeated.

The power supply 300 differs from the power supply 200 by the inclusion of one or more noise cancelling transformers to further attenuation common mode noise at the DC output 195. A noise cancelling transformer may also be called a “common mode choke”. A first noise cancelling transformer 324 may be incorporated within the primary side filter 220. A second noise cancelling transformer 365 may be incorporated in series with the DC output 195.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A power supply comprising:
a power transformer having a primary winding and a secondary winding, one end of the secondary winding connected to ground;
a shielded isolation transformer having a third winding, a fourth winding, and a shield, wherein the third winding is connected to the secondary winding and the shield is connected to ground;
primary side circuits to receive input power and generate a primary AC signal to drive the primary winding; and
secondary side circuits to convert a secondary AC signal output from the fourth winding to provide a DC output.

2. The power supply of claim 1, the secondary side circuits further comprising:
an established reliability capacitor having a capacitance value of 0 pF to 100 pF connected from the DC output to ground.

3. The power supply of claim 2, wherein the end of the secondary winding, the shield, and
the capacitor are connected to ground at a common point.

4. The power supply of claim 1, wherein the secondary side circuits comprise:
a noise cancelling transformer in series with the DC output.

5. The power supply of claim 1, wherein the primary side circuits comprise:
a noise cancelling transformer to reduce common mode noise introduced on the input power.

6. The power supply of claim 1, wherein
the power supply is configured to receive DC input power, and
the primary side circuits further comprise an inverter to generate the primary AC signal from the DC input power.

7. The power supply of claim 6, wherein
the power supply is configured to receive AC input power, and
the primary side circuits further comprise:
a rectifier and filter to convert the AC power into internal DC power, and
an inverter to generate the primary AC signal from the internal DC power.

8. The power supply of claim 1, wherein
the secondary side circuits include a feedback circuit, and
the primary side circuits include a control circuit optically coupled to the feedback circuit.
